(19) United States
(12) Patent Application Publication
(10) Pub. No.: US 2007/0195650 A1
(43) Pub. Date: Aug. 23, 2007

(54) Timepiece

(75) Inventors: Hideki Kamiya, Okaya-shi (JP); Eiichi Hiraya, Shiojiri-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/703,798

(22) Filed: Feb. 8, 2007

(30) Foreign Application Priority Data
Feb. 22, 2006 (JP) JP 2006-044866
Oct. 20, 2006 (JP) JP 2006-286448

(51) Int. Cl. G04B 19/00; G04C 17/00

(52) U.S. Cl. 368/223

(57) ABSTRACT

A timepiece enables knowing the cumulative drive time indicating how long the timepiece was actually operating. The timepiece 10 has a movement 20, hands disposed to the time display wheel train of the movement 20 for indicating the time, and a month display ring 41 and year display ring 51 that are connected to the movement 20 and count how long the drive source has been driving inside a case. The movement 20 includes a movement barrel 30 housing a spring as the power source, a time display wheel train linked to rotation of the movement barrel 30, and a cumulative drive time display mechanism that operates in conjunction with rotation of and transfers torque from the movement barrel 30. The case includes at least a crystal, a casing 11, and a back cover 12. Part of the back cover 12 is transparent to enable viewing the month display ring 41 and year display ring 51.

### BACKGROUND

1. Technical Field

The present invention relates generally to a timepiece, and relates more particularly to timepieces having a cumulative drive time display function for displaying the cumulative drive time that the timepiece is operating.

2. Related Art

Timepieces having functions for displaying time and time-related information such as the current time, elapsed time, and date information using analog hands or a digital display are common.

Chronographs are timepieces for keeping the elapsed time and display the elapsed time using a chronograph second hand, a chronograph minute hand, and a chronograph hour hand as taught, for example, in Japanese Unexamined Patent Appl. Pub. JP-A-H9-178868.

The timepiece taught in JP-A-H9-178868 uses an external operating member to accumulate the elapsed time by means of an operation that connects and disconnects the display means from the drive power source. The normal time display mechanism continues operating while the chronograph is stopped. The drive unit is thus constantly driven in timepieces that have a drive unit, including mechanical timepieces and electronically-controlled mechanical timepieces, resulting in gear wear, for example, that results in a drop in precision over time. Such timepieces can be regularly overhauled, however, to maintain the same performance over a long period of time.

A problem with such timepieces is that there is no way to know when the timepiece should be overhauled. One way to solve this problem is to record when the timepiece was manufactured or purchased and recommend an overhaul every five years thereafter, for example. If the timepiece is left unused for long periods, however, it may be difficult to know how long the drive unit of the timepiece was actually operating.

### SUMMARY

The present invention affords a timepiece that keeps track of and displays the cumulative drive time indicating how long the timepiece was actually driven so that the timepiece can be overhauled or inspected and cleaned at an appropriate time.

A timepiece according to a preferred aspect of the invention has a movement having a power source, a first wheel train for transferring torque in conjunction with rotation of the power source, and a second wheel train that transfers torque in conjunction with rotation of the power source independently of the first wheel train; a time display member disposed to the first wheel train; and a cumulative drive time display member disposed to the second wheel train for displaying a cumulative drive time denoting the cumulative time that the power source is driving.

Timepieces of this type include wristwatches and chronographs.

A timepiece according to the present invention has a cumulative drive time display mechanism that stops when the power source stops and operates when the power source is driving, and can therefore display the cumulative time that the timepiece is actually operating. If an overhaul is recommended after five years cumulative use, for example, and the cumulative drive time display mechanism enables knowing the cumulative drive time, the timepiece can be inspected or overhauled before the timepiece malfunctions, and timepiece performance can be maintained for a long time.

Providing a cumulative drive time display mechanism also affords timepieces with a new, innovative design not previously available.

Preferably, the display member for displaying the cumulative drive time is a display plate having a scale indicating the cumulative drive time.

Yet further preferably, the cumulative drive time is indicated using markings or numbers indicating month and year units.

Because the display member has numbers or markings denoting the cumulative drive time, the display member can be rendered as a thin, flat member. More specifically, the display member can be rendered within the thickness of the movement using a display member that shows the cumulative drive time while still affording a thin timepiece.

Yet further preferably, the display member for displaying the cumulative drive time is a hand, and a scale indicating the cumulative drive time is added at the edge of or below the rotational range of the hand.

By using hands as the display member for displaying the cumulative drive time, the cumulative drive time can be displayed in more precise increments than is possible with the display plate noted above.

In addition, if the timepiece uses hands to show the current time or chronograph time, using analog hands to also display the cumulative drive time means that analog hands indicate all displayed time information, thus affording a timepiece with an aesthetically balanced design.

Yet further preferably, the display member for displaying the cumulative drive time is disposed on the opposite side of the movement as the time display member.

The time display member is disposed on the side of the timepiece that is normally visible (such as the face of a wristwatch), and the display member for displaying the cumulative drive time is disposed on the opposite side as the time display member (the back of a wristwatch in this example). Because it is not normally necessary to see the cumulative drive time, displaying the cumulative drive time on the back side of the timepiece will not interfere with displaying the current time or chronograph time.

Yet further preferably, the display member for displaying the cumulative drive time has a month display member and a year display member.

A timepiece overhaul is generally recommended every three to five years. By displaying the cumulative drive time in at least year units, and preferably in month units, the user can know that the cumulative drive time of the timepiece has reached three years and six months, for example, and can have the timepiece overhauled or cleaned as needed.

Yet further preferably, the power source is a spring.

Timepieces that use a spring as the power source include mechanical timepieces and electronically controlled mechanical timepieces, and a regular overhaul is recommended because the torque load on the wheel trains, for example, is high. The present invention enables knowing the cumulative drive time and thus facilitates having the timepiece overhauled or inspected at an appropriate interval.

Furthermore, because timepieces that use a spring for drive power can be used by simply winding the spring, such timepieces may also be left unused with the spring completely unwound for long periods of time. Even in such cases, however, the present invention enables knowing the actual cumulative drive time so that the timepiece can be overhauled or maintained as recommended.

Yet further preferably, the timepiece also has a power reserve wheel train for displaying the reserve power of the spring, and a wheel in the second wheel train is a part of the power reserve wheel train.

By thus using common components in the power reserve wheel train and the second wheel train, the parts count can be reduced and increasing the size of the timepiece can be suppressed.

Yet further preferably, the movement, the time display member, and the cumulative drive time display member are disposed inside a case including a crystal, a casing, and a back cover; and a part of the back cover is a transparent member enabling viewing the cumulative drive time display member.

By disposing the display member that shows the cumulative drive time on the back cover side of the timepiece so that the cumulative drive time is visible from the back, the user can easily check the cumulative drive time at any time.

The timepiece of the invention thus has display members with different display functions on the front and back of the timepiece, and thus affords timepieces having a fresh, innovative design.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a plan view from the back of a timepiece according to a first embodiment of the invention.

FIG. 2 is a schematic plan view showing the arrangement of the cumulative drive time display mechanism in a first embodiment of the invention.

FIG. 3 is a plan view of a first wheel train in the first embodiment of the invention.

FIG. 4 is a section view of a first wheel train in the first embodiment of the invention.

FIG. 5 is a section view showing the arrangement of the cumulative drive time display mechanism in the first embodiment of the invention.

FIG. 6 describes the concept of cumulative drive time in the first embodiment of the invention.

FIG. 7 is a partial section view showing the cumulative drive time display mechanism in a second embodiment of the invention.

FIG. 8 is a plan view showing the relationship between the month hand and year hand and the month scale and year scale in the second embodiment of the invention.

FIG. 9 is a schematic plan view showing the arrangement of the cumulative drive time display mechanism in a third embodiment of the invention.

FIG. 10 is a section view showing the power reserve wheel train according to a third embodiment of the invention.

### DESCRIPTION OF EXEMPLARY EMBODIMENTS

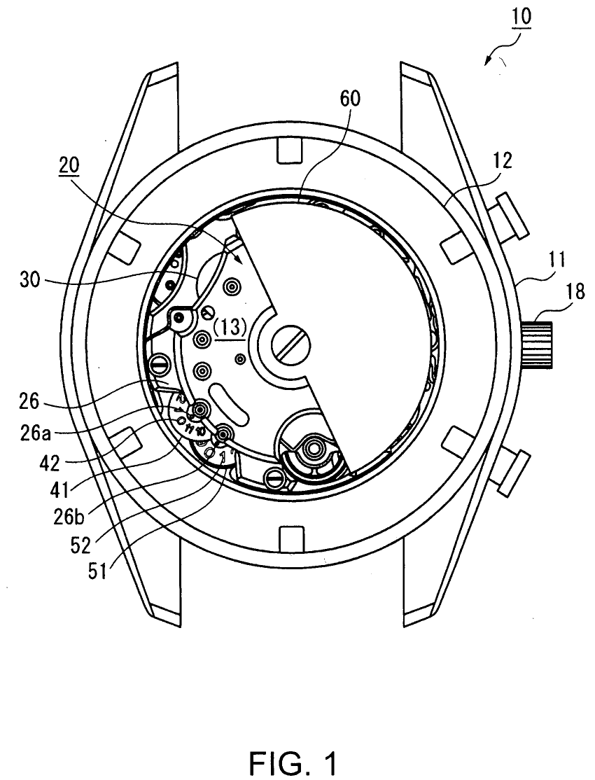

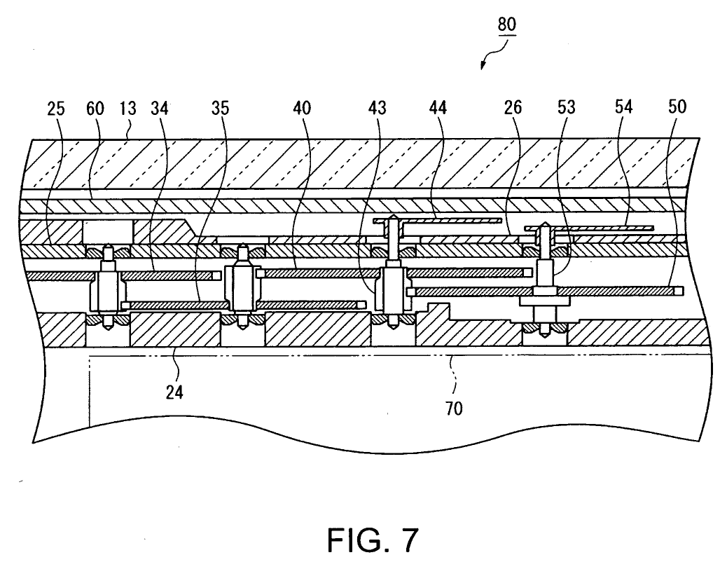

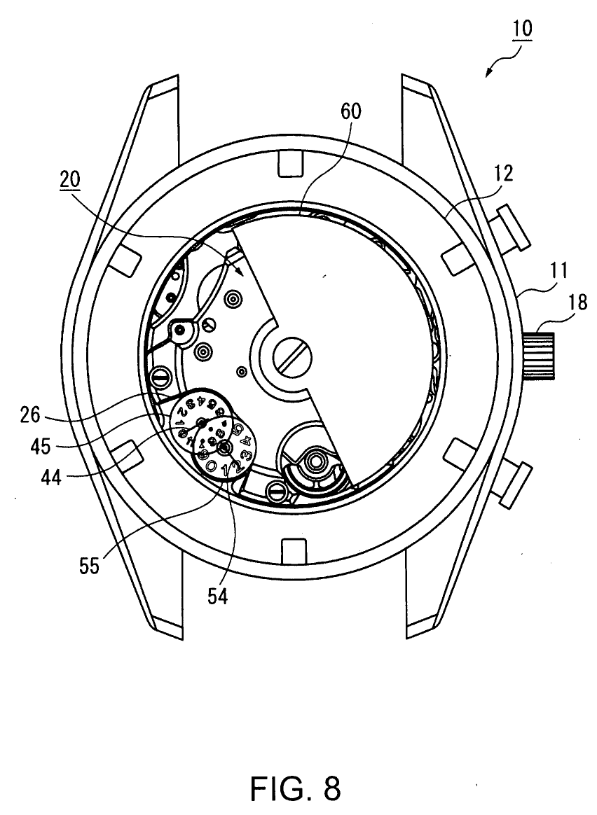

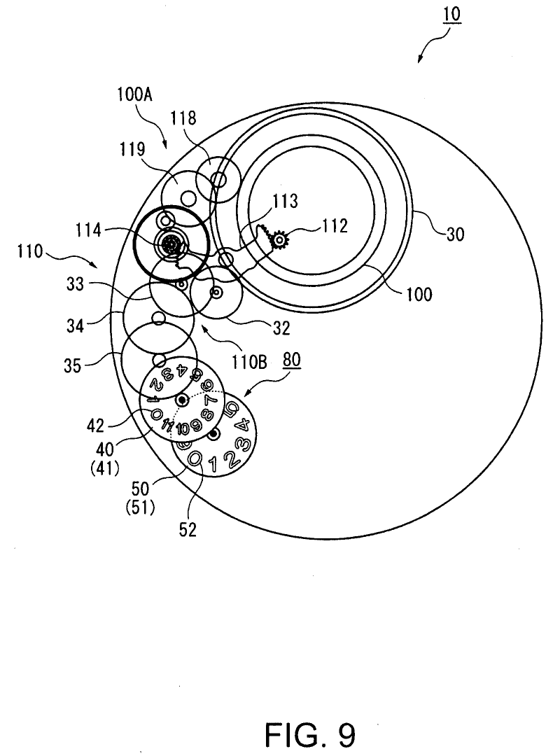

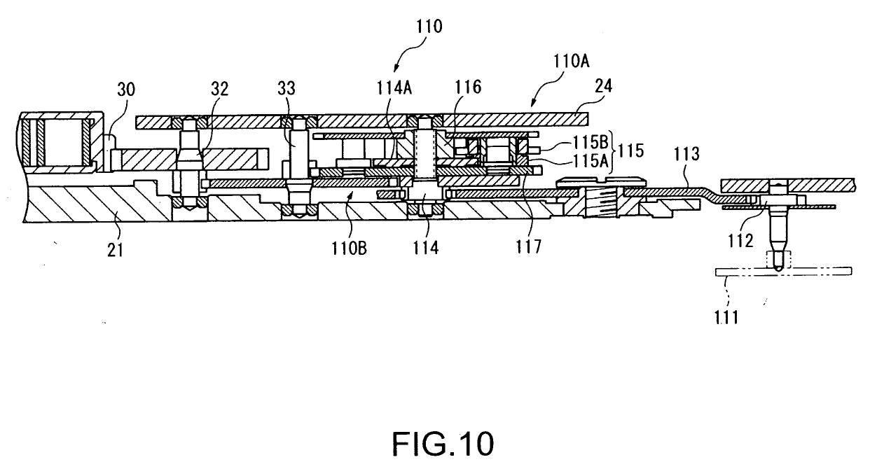

Preferred embodiments of the present invention are described below with reference to the accompanying figures. FIG. 1 to FIG. 6 show a timepiece 10 according to a first embodiment of the invention. FIG. 7 and FIG. 8 show a timepiece 10 according to a second embodiment of the invention, and FIG. 9 and FIG. 10 show a timepiece 10 according to a third embodiment of the invention.

### Embodiment 1

FIG. 1 is a plan view from the back of a timepiece 10 according to a first embodiment of the invention. The timepiece 10 according to this embodiment of the invention shown in FIG. 1 has a case including a casing 11, a back cover 12, and a crystal 14 (not shown in the figure), and a movement 20 housed inside the case.

This aspect of the invention is described using a mechanical chronograph wristwatch by way of example. This wristwatch has a crown 18 at the 3:00 o'clock position, and external push-buttons at the 2:00 and 4:00 o'clock positions. A transparent crystal 13 rendered in the back cover 12 enables viewing the greater part of the movement 20 from the outside.

A month display ring 41 and a year display ring 51 are provided below the rotary pendulum bridge 26 near the 8:00 o'clock position as the display means of the cumulative drive time display member so that the month display ring 41 and year display ring 51 can be seen through the crystal 13 when the rotary pendulum 60 is moved to the side as seen in FIG. 1. A month scale 42 and a year scale 52 are provided on the surface of the month display ring 41 and year display ring 51, respectively.

The cumulative drive time display mechanism is described next with reference to the accompanying figures.

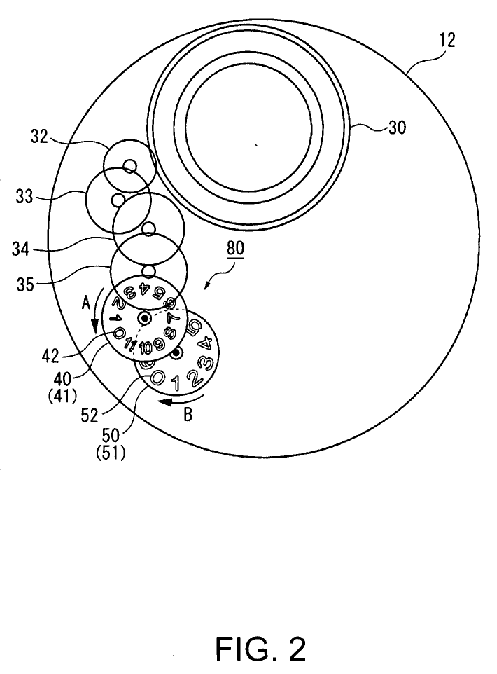

FIG. 2 is a schematic plan view of the cumulative drive time display mechanism 80 according to this embodiment of the invention. The cumulative drive time display mechanism 80 rendered as a second wheel train as shown in FIG. 2 is a speed-reducing wheel train including a transfer wheel 32 that is connected to the movement barrel 30 holding the mainspring, a first accumulator middle wheel 33, a second accumulator middle wheel 34, a third accumulator middle wheel 35, a fourth accumulator middle wheel 40, and an accumulator wheel 50.

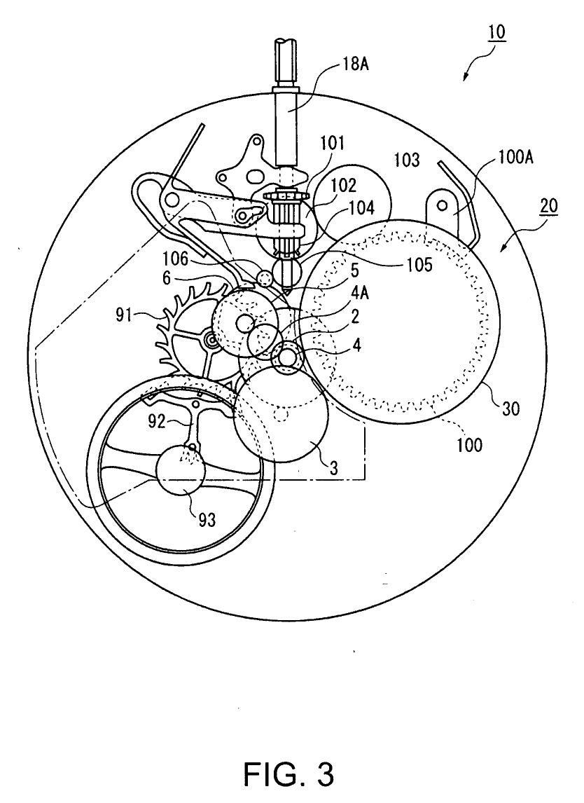

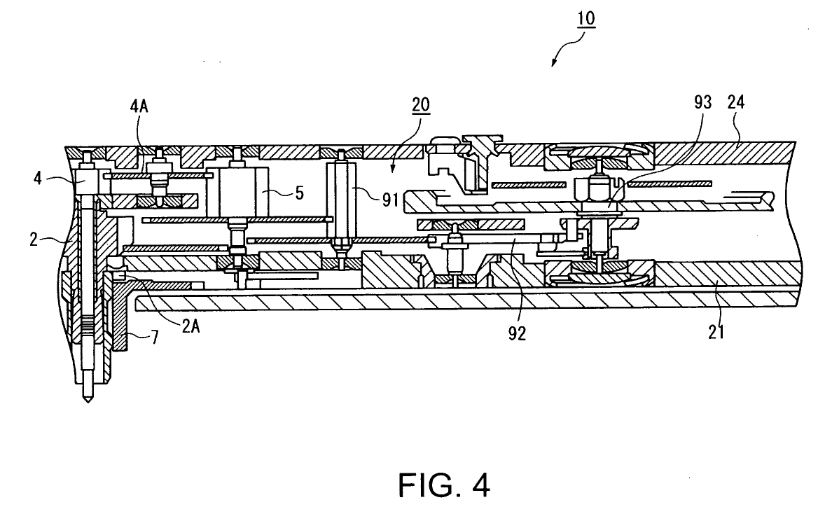

In contrast to this second wheel train, the first wheel train displays the current time and can be rendered using a common mechanical watch mechanism. As shown in FIG. 3 and FIG. 4, the first wheel train is a speed-increasing wheel train that transfers power from the second wheel (minute hand wheel) 2, which is linked to the movement barrel 30, to the third wheel 3, fourth wheel (second hand wheel) 4, intermediate wheel 4A, fifth wheel 5, and a mechanical escapement or governor mechanism. Power is further transferred from the cannon pinion 2A of the second wheel 2 to the day wheel 6 and center wheel 7. The first wheel train and the second wheel train are thus independent mechanisms that share a common power source.

The fifth wheel 5 engages the escapement wheel 91 to transfer power to the mechanical escapement. The escapement includes the escapement wheel 91, pallet 92, and balance 93, and produces the time standard. The construction and operation of the escapement are known from the literature, and further detailed description thereof is thus omitted. Detailed description of the chronograph mechanism is also omitted in the figures.

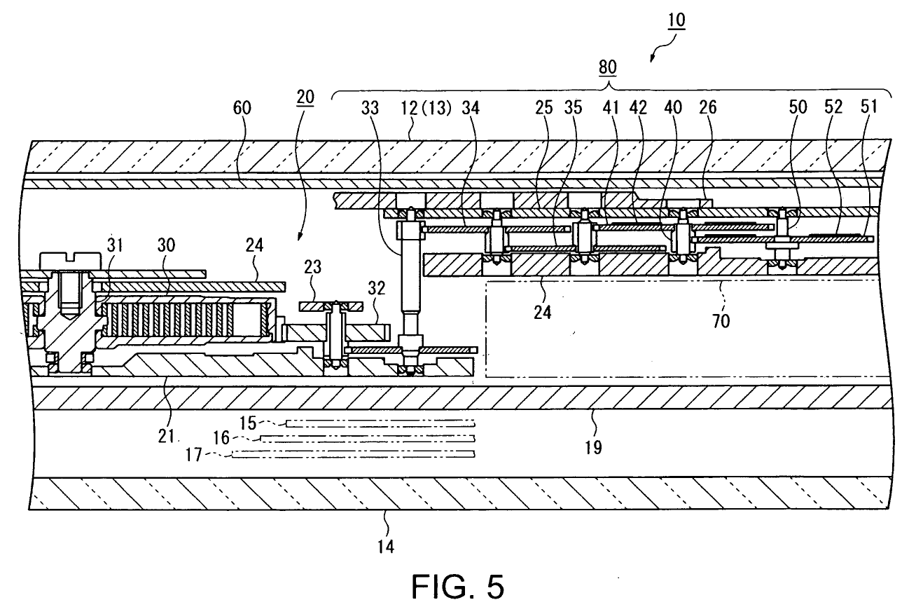

The ratchet wheel 100 is wound to wind the mainspring, and the ratchet wheel 100 is wound by turning the crown 18 to rotate the stem 18A connected to the crown 18, thereby transferring rotation of the stem 18A through the winding pinion 101 to the crown wheel 102 and the intermediate ratchet wheel 103. The direction of ratchet wheel 100 rotation is restricted by the click 10A. The minute hand 16 and hour hand 15 (see FIG. 5) are set by similarly turning the stem 18A to turn the clutch wheel 104 [014, sic], the set wheel 105, the intermediate day wheel 106, and the day wheel 6.

Referring again to FIG. 2, rotation of the movement barrel 30 is speed reduced by the wheels in the cumulative drive time display mechanism 80 so that the fourth accumulator middle wheel 40 rotates once a year and the accumulator wheel 50 rotates once in ten years. A scale of numbers denoting the months is displayed on the month display ring 41 on the fourth accumulator middle wheel 40, which turns in the direction of arrow A. A scale of numbers denoting the year is displayed on the year display ring 51 of the accumulator wheel 50, which turns in the direction of arrow B. These scales can be seen through a window rendered in the rotary pendulum bridge 26 as shown in FIG. 1.

The cumulative drive time can be read from the numbers on the month display ring 41 and year display ring 51 that are aligned with the index marks 26a and 26b that are engraved on the rotary pendulum bridge 26 as shown in FIG. 1. Both the month display ring 41 and year display ring 51 thus indicate 0 when aligned as shown in FIG. 1, indicating that driving this timepiece 10 has not started.

Because the movement barrel 30 rotates continuously, the fourth accumulator middle wheel 40 and accumulator wheel 50 also rotate continuously. The numeric scales therefore also continuously advance in small increments so that times shorter than one month can be inferred from the position of the scale.

Note that the scales presented on the month display ring 41 and year display ring 51 are by way of example only, and the scales can be suitably determined according to the specifications of the timepiece 10.

The arrangement of the cumulative drive time display mechanism 80 in this aspect of the invention is described in further detail below with reference to FIG. 5.

The arrangement of the cumulative drive time display mechanism 80 in this aspect of the invention is described below referring to the section view thereof in FIG. 5 and focusing on the parts that are particularly relevant to the present invention. Referring to FIG. 5, the movement barrel 30 houses the mainspring that is the power source not shown of the movement, and the barrel arbor 31 is axially supported between the main plate 21 and the train wheel bridge 24.

Rotation of the movement barrel 30 is transferred by the transfer wheel 32 to the first accumulator middle wheel 33. The transfer wheel 32 is axially supported by the main plate 21 and second bridge 23, and the first accumulator middle wheel 33 is axially supported by the main plate 21 and fourth bridge 25. The first accumulator middle wheel 33 is disposed passing through the movement 20 from the main plate 21 on the crystal 14 side of the timepiece to the fourth bridge 25 on the back cover 12 side of the timepiece. Rotation of the movement barrel 30 disposed on the main plate 21 side of the movement 20 is thus transferred to the cumulative drive time display mechanism 80 disposed on the back cover 12 side of the timepiece.

Rotation of the first accumulator middle wheel 33 is transferred sequentially through the second accumulator middle wheel 34, the third accumulator middle wheel 35, the fourth accumulator middle wheel 40, and to the accumulator wheel 50. The second accumulator middle wheel 34, the third accumulator middle wheel 35, the fourth accumulator middle wheel 40, and the accumulator wheel 50 are axially supported by the train wheel bridge 24 and fourth bridge 25, and reduce the speed of movement barrel 30 rotation so that the fourth accumulator middle wheel 40 turns one revolution per year and the accumulator wheel 50 turns one revolution over ten years.

A month scale 42 is rendered on the surface of the month display ring 41 of the fourth accumulator middle wheel 40 and a year scale 52 is rendered on the surface of the year display ring 51 of the accumulator wheel 50 by, for example, printing the scales. Also see FIG. 2.

This embodiment of the invention uses a self-winding mechanism having the rotary pendulum bridge 26 disposed on top of the fourth bridge 25, and a rotary pendulum 60 disposed on the rotary pendulum bridge 26. Self-winding mechanisms are known from the literatures, and further detailed description thereof is thus omitted here.

The second accumulator middle wheel 34, third accumulator middle wheel 35, fourth accumulator middle wheel 40, and accumulator wheel 50 that constitute the major portion of the cumulative drive time display mechanism 80 are disposed above the time display mechanism 70 as seen in FIG. 5. Though not shown in the figure, the time display mechanism 70 includes the time display wheel train and governor mechanism of the first wheel train. The time display wheel train and governor mechanism generally include the escapement and wheel train in a mechanical timepiece, and include a governor coil or rotor, for example, in an electronically controlled mechanical timepiece.

The hour hand 15, the minute hand 16, and the second hand 17 are disposed as the time display members in the space between the dial 19 and the crystal 14 on the main plate 21 side of the timepiece 10. In a chronograph watch the plural chronograph hands are also rendered in this space between the dial 19 and crystal 14. The hands for the normal time display and the hands for displaying the chronograph time are thus located on the crystal 14 side of the timepiece, and the cumulative drive time display is rendered on the opposite back cover 12 with the movement 20 between the current time display and the cumulative drive time display.

A crystal 13 made from transparent glass or other transparent material is rendered in the back cover 12 in the area including the fourth accumulator middle wheel 40 and accumulator wheel 50 so that the user can easily read the cumulative drive time through the back cover 12.

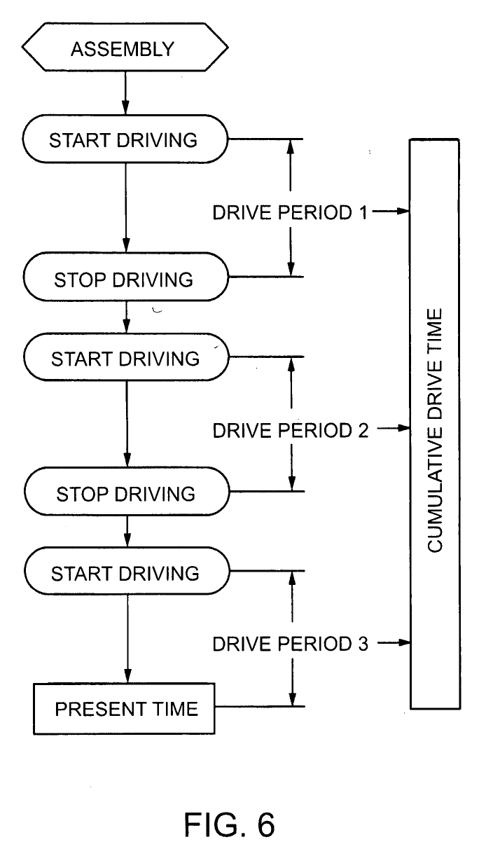

Cumulative drive time as used in this embodiment of the invention is described next with reference to FIG. 2, FIG. 5, and FIG. 6.

FIG. 6 describes the cumulative drive time. The timepiece is first assembled. At this time the mainspring that provides power is completely unwound and the month scale 42 on the month display ring 41 of the fourth accumulator middle wheel 40 and the year scale 52 on the year display ring 51 of the accumulator wheel 50 are both set so that the 0 on each is aligned with the corresponding index mark 26a and 26b. The movement barrel 30 then starts driving when the spring is wound. This also starts driving the cumulative drive time display mechanism 80.

When the timepiece 10 (movement barrel 30) stops, the cumulative drive time display mechanism 80 also stops. The time from when driving started to when driving stopped is referred to as “drive period 1” herein. The period from when the spring is wound again and driving starts until driving again stops is referred to as “drive period 2.” The period from when the spring is then wound again and driving starts until driving stops a third time is referred to as “drive period 3.” Because the cumulative drive time display mechanism 80 is linked to the movement barrel 30, the cumulative drive time display mechanism 80 operates only when the movement barrel 30 is turning, and the total drive time accumulated through drive period 1, drive period 2, and drive period 3 can therefore be read from the month scale 42 and year scale 52 on the month display ring 41 and year display ring 51.

Driving starts and stops when the spring is wound and fully unwinds. Alternatively, if the timepiece has a regulating mechanism such as a stopwatch function, starting and stopping the cumulative drive time display mechanism 80 can be linked to releasing and engaging the regulating mechanism.

The timepiece described in this first embodiment of the invention can thus easily display the cumulative time that the timepiece has actually operated as a result of the cumulative drive time display mechanism 80 that stops when the movement barrel 30 stops and drives continuously when the movement barrel 30 is turning. If an overhaul or inspection and maintenance is recommended when the cumulative drive time reaches five years, for example, the cumulative drive time can be monitored by reading the cumulative drive time display mechanism 80 so that the timepiece can be inspected or overhauled before the timepiece fails so that timepiece performance can be maintained for a long time.

Furthermore, rendering the current time and chronograph time displays on the crystal 14 side of the timepiece, which is typically the face side in a wristwatch, and the month and year scales of the cumulative drive time display on the back cover 12 side (the back of the wristwatch) affords a timepiece with a new, innovative design.

The timepiece is generally placed for use with the current time displayed visibly to the user and the month scale 42 and year scale 52 for displaying the cumulative drive time on the opposite side as the current time display. Being able to read the cumulative drive time is not normally necessary, and by rendering the cumulative drive time display on the back of the timepiece, displaying the cumulative drive time does not interfere with reading the current time or the chronograph time when chronograph hands are also provided.

Overhauling a timepiece is generally recommended every three to five years. The timepiece can therefore be overhauled or maintained appropriately by tracking the cumulative drive time in terms of months and years.

Timepieces that use a spring for drive power include mechanical timepieces and electronically controlled mechanical timepieces, and a regular overhaul is recommended because the torque load on the wheel trains, for example, is high. The present invention can therefore be used to great advantage in such timepieces.

Furthermore, because timepieces that use a spring for drive power can be used by simply winding the spring, such timepieces may also be left unused with the spring completely unwound for long periods of time. Even in such cases, however, the present invention enables knowing the actual cumulative drive time so that the timepiece can overhauled be or maintained as recommended.

Furthermore, the month display ring 41 and year display ring 51 that display the cumulative drive time can be rendered as thin plates that can be disposed below the fourth bridge 25. By thus rendering the month display ring 41 and year display ring 51 within the thickness of the movement 20, the cumulative drive time display mechanism of the invention can be rendered in a thin timepiece.

### Embodiment 2

A timepiece 10 according to a second embodiment of the invention is described next. The first embodiment of the invention uses the month display ring 41 and year display ring 51 as the display members for displaying the cumulative drive time. This second embodiment of the invention differs from the first embodiment by using hands to display the cumulative drive time. Like parts in the first and second embodiments are therefore identified by like reference numerals and further description thereof is omitted here.

FIG. 7 is a partial section view showing the cumulative drive time display mechanism 80 in this second embodiment of the invention. The top spindle of the pinion 43 of the fourth accumulator middle wheel 40 extends through the fourth bridge 25 and axially supports the month hand 44. The top spindle of the, accumulator wheel arbor 53 of the accumulator wheel 50 likewise passes through the fourth bridge 25 and axially supports the year hand 54.

The thickness of the rotary pendulum bridge 26 is reduced in the area of the month hand 44 and year hand 54 (see also FIG. 8). A space enabling the rotary pendulum 60 to rotate is provided above the month hand 44 and year hand 54. A month scale 45 and a year scale 55 are printed, embossed, or otherwise formed on the surface of the rotary pendulum bridge 26 below the month hand 44 and year hand 54.

FIG. 8 is a plan view showing the relative positions of the month hand 44 and year hand 54 to the month scale 45 and year scale 55. As shown in FIG. 8 the month scale 45 is disposed on the rotary pendulum bridge 26 below the month hand 44, and the year scale 55 is disposed on the rotary pendulum bridge 26 below the year hand 54.

Parts of the month scale 45 and year scale 55 also overlap because the month hand 44 and year hand 54 overlap in part as shown in FIG. 8. The numbers of the month scale 45 and year scale 55 are therefore shown as dots in the figure in this overlapping area where showing the numbers in the figure would be confusing.

The scales are also not limited to using numbers and other means can be used. For example, the scales could start with a 0 at the starting reference point while using a series of hash marks to indicate intervals that are difficult to write with numbers.

The month scale 45 and year scale 55 can also be rendered around the edges of the areas through which the month hand 44 and year hand 54 rotate.

A timepiece according to this second embodiment of the invention in which hands are used as the display members for displaying the cumulative drive time can thus indicate the cumulative drive time in fine increments. Furthermore, using analog hands as the display members for indicating the cumulative drive time while also using hands to display the current time and chronograph time creates the impression of a high precision movement and affords a timepiece with a well balanced aesthetic design.

### Embodiment 3

The timepiece 10 according to a third embodiment of the invention as shown in FIG. 9 and FIG. 10 also has a power reserve wheel train 110 for measuring winding and unwinding of the mainspring.

This power reserve wheel train 110 has a power reserve hand wheel 112, an odd-shaped intermediate wheel 113 that engages the power reserve hand wheel 112, a first sun wheel 114 that engages the intermediate wheel 113, a planetary wheel 115, a second sun wheel 116, and an intermediate planetary wheel 117 to which the planetary wheel 115 is affixed.

A power reserve hand 111 for indicating the remaining reserve power of the mainspring is affixed the power reserve hand wheel 112.

The planetary wheel 115 has a first planetary wheel 115A that engages the sun wheel 114A of the first sun wheel 114, and a second planetary wheel 115B that is rendered in unison with the first planetary wheel 115A. The second sun wheel 116 engages the second planetary wheel 115B of the planetary wheel 115, and the planetary wheel 115 is affixed to the intermediate planetary wheel 117.

The second sun wheel 116 is connected to the ratchet wheel 100 through a second winding transfer wheel 119 and a first winding transfer wheel 118. The intermediate planetary wheel 117 is connected to the movement barrel 30 through the first accumulator middle wheel 33 and transfer wheel 32.

When the ratchet wheel 100 is turned by the spring winding operation, the torque is sequentially reduced by the first winding transfer wheel 118 and second winding transfer wheel 119 and transferred to the second sun wheel 116 and planetary wheel 115. When the spring is being wound the movement barrel 30 turns very slowly or is stopped. As a result, the transfer wheel 32, first accumulator middle wheel 33, and intermediate planetary wheel 117 are thus stationary, the torque passed to the planetary wheel 115 is transferred to the first sun wheel 114, intermediate wheel 113, power reserve hand wheel 112, and power reserve hand 111. The power reserve hand 111 thus moves in one direction.

The ratchet wheel 100 is stopped when the spring is unwinding, and the wheel train from the first winding transfer wheel 118 to the second sun wheel 116 therefore also stops. When the movement barrel 30 turns and the spring unwinds, torque is speed-reduced while being transferred from the transfer wheel 32 and first accumulator middle wheel 33 to the intermediate planetary wheel 117. Because the intermediate planetary wheel 117 with which the planetary wheel 115 is engaged is stopped, the planetary wheel 115 rotates while revolving around the intermediate planetary wheel 117. The first sun wheel 114 that meshes with the planetary wheel 115 therefore turns opposite the direction of rotation when the spring is being wound, and the intermediate wheel 113, the power reserve hand wheel 112, and the power reserve hand 111 also turn in the opposite direction.

The first winding transfer wheel 118, intermediate planetary wheel 117, second sun wheel 116, and planetary wheel 115 that transfer torque from the ratchet wheel 100 to the first sun wheel 114 render a spring-winding wheel train 110A in the power reserve wheel train 110, and the transfer wheel 32, first accumulator middle wheel 33, intermediate planetary wheel 117, and planetary wheel 115 that transfer torque from the movement barrel 30 to the first sun wheel 114 render an unwinding wheel train 110B.

Part of the unwinding wheel train 110B is thus rendered by the transfer wheel 32 and first accumulator middle wheel 33 that are used in the speed-reducing wheel train of the cumulative drive time display mechanism 80 in this embodiment of the invention. The transfer wheel 32 and first accumulator middle wheel 33 are thus shared by the power reserve wheel train 110 and cumulative drive time display mechanism 80, dedicated wheels are therefore not needed to render the power reserve wheel train 110, and an increase in the size of the timepiece 10 movement can be suppressed.

Furthermore, while cumulative time is displayed on the back of the timepiece 10, the remaining continuous time is displayed on the face of the timepiece 10 by means of the intermediate wheel 113, power reserve hand wheel 112, and power reserve hand 111 disposed on the face side of the movement. As a result, and while not shown in FIG. 10, the gear portion and the pinion of the first accumulator middle wheel 33 and second accumulator middle wheel 34 (FIG. 9) are disposed coaxially but separated to the front and back of the timepiece. More specifically, the gear portion is disposed towards the timepiece face while the pinion is disposed towards the back cover. As a result, the third accumulator middle wheel 35, the fourth accumulator middle wheel 40, and the accumulator wheel 50 are located towards the back of the timepiece so that the cumulative drive time is displayed at the back of the timepiece 10.

The present invention is not limited to the embodiments described above, and can be varied and improved in many ways without departing from the scope of the accompanying claims.

The first and second embodiments of the invention are described herein using a mechanical timepiece or an electronically controlled mechanical timepiece by way of example, but the invention can also be used with battery-powered analog timepieces.

When a battery is used as the power supply, driving stops when the battery is exhausted, and this timing is conventionally used as the timing for an overhaul or maintenance, but power reserve timepieces and timepieces having an internal power generator have been introduced due to problems resulting from reduced battery capacity and power consumption. Rendering the cumulative drive time display mechanism 80 of the present invention in such power reserve timepieces and timepieces with an internal generator thus enables knowing when an overhaul or maintenance is needed.

The cumulative drive time is displayed in month and year units in the first to third embodiments of the invention described above, but can be displayed in year units alone. This enables increasing the size of the year markings or providing a scale for a greater number of years, such as twenty years.,

The cumulative drive time can also be reset to zero during the overhaul or regular maintenance, in which case the cumulative drive time will display the drive time since the last overhaul or maintenance.

The present invention is also not limited to use in wristwatches, can be used in various kinds of clocks, including clocks having the movement housed inside a case and clocks having the movement not housed inside a case.

The first to third aspects of the invention described herein thus enable knowing the cumulative drive time denoting the actual operating time of the timepiece, and thus afford a timepiece enabling knowing when the timepiece is due for an overhaul or maintenance.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

The entire disclosure of Japanese Patent Application Nos. 2006-044866, filed Feb. 22, 2006 and 2006-286448, filed Oct. 20, 2006 are expressly incorporated by reference herein.

What is claimed is:

1. A timepiece comprising:
a movement having a power source, a first wheel train for transferring torque in conjunction with rotation of the power source, and a second wheel train that transfers torque in conjunction with rotation of the power source independently of the first wheel train;
a time display member disposed to the first wheel train; and
a cumulative drive time display member disposed to the second wheel train for displaying a cumulative drive time denoting the cumulative time that the power source is driving.

2. The timepiece described in claim 1, wherein the display member for displaying the cumulative drive time is a display plate having a scale indicating the cumulative drive time.

3. The timepiece described in claim 1, wherein the display member for displaying the cumulative drive time is a hand, and a scale indicating the cumulative drive time is added at the edge of or below the rotational range of the hand.

4. The timepiece described in claim 1, wherein the display member for displaying the cumulative drive time is disposed on the opposite side of the movement as the time display member.

5. The timepiece described in claim 1, wherein the display member for displaying the cumulative drive time has a month display member and a year display member.

6. The timepiece described in claim 1, wherein the power source is a spring.

7. The timepiece described in claim 6, further comprising a power reserve wheel train for displaying the reserve power of the spring, wherein a wheel in the second wheel train is a part of the power reserve wheel train.

8. The timepiece described in claim 1, wherein the movement, the time display member, and the cumulative drive time display member are disposed inside a case including a crystal, a casing, and a back cover; and
a part of the back cover is a transparent member enabling viewing the cumulative drive time display member.
